(19) United States
(12) Patent Application Publication
(10) Pub. No.: US 2012/0091086 A1
(43) Pub. Date: Apr. 19, 2012

(54) RAIL STORAGE SYSTEM

(75) Inventors: Michael Gregory, Huntersville, NC (US); Robert J. Warner, JR., Charlotte, NC (US)

(73) Assignee: RUBBERMAID INCORPORATED, Huntersville, NC (US)

(21) Appl. No.: 12/906,686

(22) Filed: Oct. 18, 2010

(51) Int. Cl. A47F 5/00; B23P 19/04

(52) U.S. Cl. 211/86.01; 29/428; 211/183

(57) ABSTRACT

A storage apparatus comprises a rail adapted to be secured to a surface and an accessory releasably mounted to the rail. The accessory comprises a gripper assembly and a storage device, the gripper assembly includes a gripper mechanism that is movably mounted relative to a support such that the gripper mechanism is movable into and out of engagement with the rail when the accessory is mounted on the rail.

### BACKGROUND

Rail storage systems typically comprise a wall mountable rail, and accessories that connect to the rail. Such systems may be used in a garage or other similar area. The accessories are designed to hold a wide variety of consumer items such as tools, bicycles, hoses, sports equipment and other consumer articles. One issue with such rail storage systems results from not having a secure mechanism to attach the accessories to the rail. When a consumer removes an item from an accessory, the accessory can be accidentally disengaged from the rail and remain entangled with the consumer's item. This issue often arises with articles that wrap underneath the accessory. If the article hits the bottom of the accessory, the upward force applied to the bottom of the accessory may result in the inadvertent disengagement of the accessory from the rail.

### SUMMARY OF THE INVENTION

The storage apparatus comprises a rail adapted to be secured to a surface and an accessory releasably mounted to the rail where the accessory comprises a gripper assembly and a storage device. The gripper assembly may comprise a gripper mechanism that is movably mounted relative to a support such that the gripper mechanism is movable into and out of engagement with the rail when the accessory is mounted on the rail.

The support may be dimensioned to extend from an upper edge of the rail to beyond the lower edge of the rail. The support may have a hook that engages the upper edge of the rail where the accessory is suspended on the rail by the hook. A flange may extend below the rail and be dimensioned such that the flange abuts or lies closely adjacent to the surface when the accessory is mounted on the rail. The gripper mechanism may comprise a latch engageable with an engagement mechanism on the rail. A spring may bias the latch toward the engagement mechanism. The latch may be positioned opposite to the engagement mechanism when the accessory is mounted on the rail. The latch may include a first cam surface that is disposed opposite a second cam surface on the engagement mechanism such that the engagement of the first cam surface with the second cam surface rotates the latch relative to the support. When a distal end of the latch clears the engagement mechanism, the latch is biased into engagement with the engagement mechanism. The latch may comprise a first mating surface that engages and grips a second mating surface on the engagement mechanism. A reinforcement member may be used to add strength and rigidity to the latch. The reinforcement member may be insert molded in the gripper mechanism and the reinforcement member may be exposed on a front surface of the gripper mechanism

A method of mounting an accessory on a rail that is mounted on a surface comprises providing a gripper assembly having a support with a hook and a body movable relative to the support where the body comprises a latch. The hook is located over an edge of the rail such that the accessory is suspended on the rail from the hook. The accessory is moved toward the rail such that the rail engages the latch to move the latch relative to the support and away from the rail. Once the accessory is properly positioned on the rail the latch is allowed to move toward the rail until a first mating surface on the latch engages a second mating surface on the rail. Thereafter, the body may be moved relative to the support to disengage the latch from the rail. After the latch is disengaged from the rail, the hook may be lifted from the edge of the rail.

An accessory for a storage apparatus comprises a gripper mechanism and a storage device. The gripper mechanism is movably mounted relative to a support such that the gripper mechanism is movable from a first position where a latch engages the rail and a second position where the latch is disengaged from the rail. The gripper mechanism is biased to the first position.

### BRIEF DESCRIPTION OF THE DRAWINGS

FIG. 1 is a front perspective view of an accessory mounted on a partial rail portion.

FIG. 2 is a side view of the accessory of FIG. 1 mounted on a rail in the unlocked position.

FIG. 3 is an exploded front view of the accessory of FIG. 1.

FIG. 4 is an exploded back view of the accessory of FIG. 1.

FIG. 5 is a detailed view of the engagement of the latch with a rail in a locked position.

FIG. 6 is a detailed view of the disengagement of the latch from a rail in an unlocked position.

FIGS. 7A and 7B are block diagrams illustrating embodiments of methods of using the accessory.

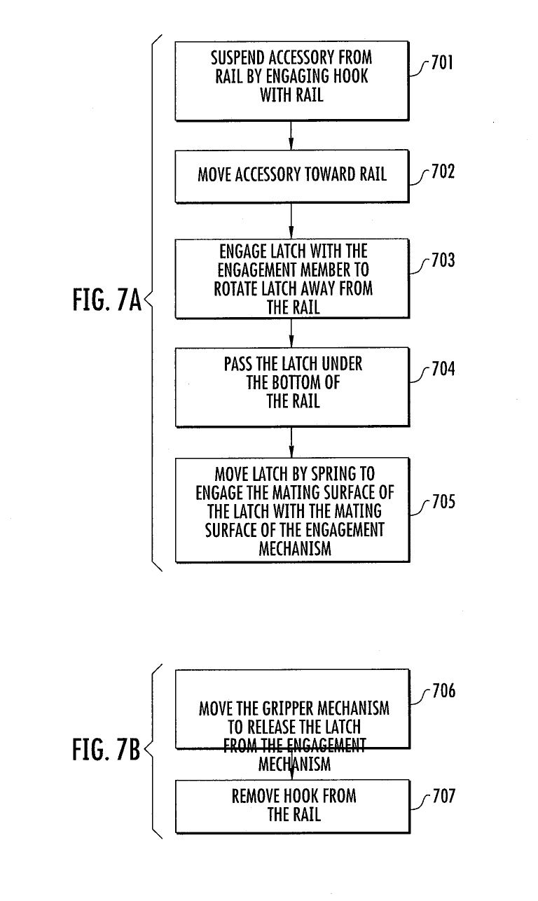

FIG. 8 is a side view of the accessory of FIG. 1 mounted on a rail in the locked position.

FIG. 9 is a side view of another embodiment of the accessory of the invention mounted on a rail in the locked position.

FIG. 10 is an exploded front view of the accessory of FIG. 9.

FIG. 11 is a detailed perspective back view of the gripper body.

### DETAILED DESCRIPTION OF EMBODIMENTS OF HE INVENTION

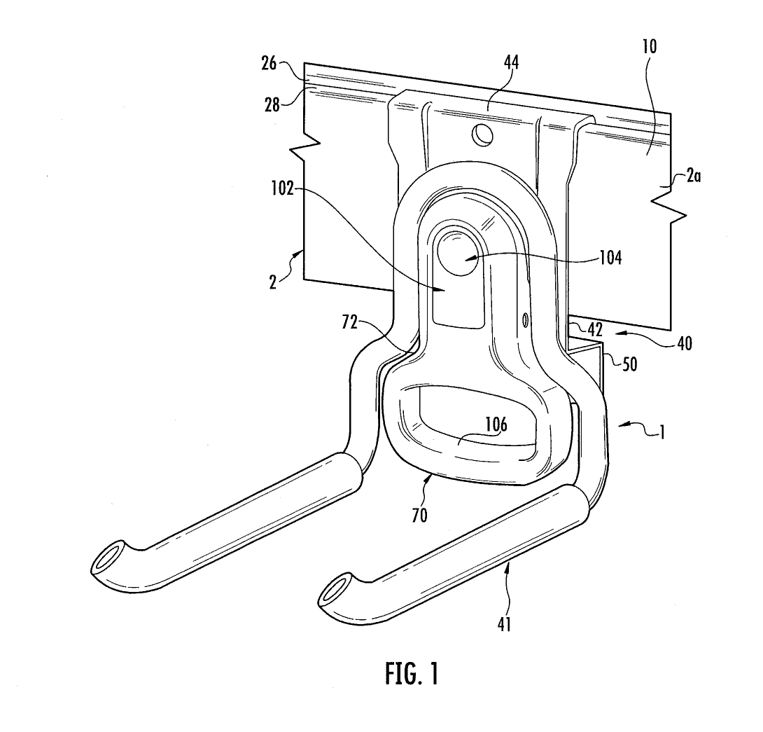

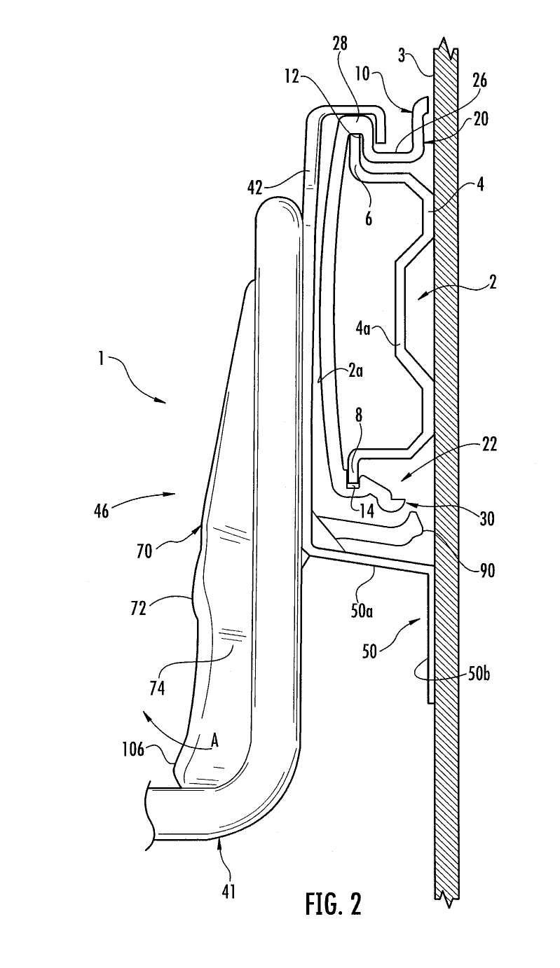

The accessory 1 will be described with reference to the rail 2, an embodiment of which is shown in FIGS. 1 and 2. While a specific embodiment of the rail is shown the accessory of the invention may be used with other rail configurations. Rail 2 extends along and is mounted to a vertical surface 3 such as a wall and may extend for an extended linear distance along the wall. In one embodiment the rail 2 is manufactured and sold in four to seven foot lengths although the rail may have any suitable length. Rail 2 may include a rail member 4 mounted to a wall or other vertical surface 3. The rail member 4 is made of steel or other rigid material and may include apertures for receiving fasteners such as screws for attaching the rail member 4 to the vertical surface 3. The rail member 4 includes a first flange 6 that extends along substantially the entire length of the upper edge of the rail member 4 and a second flange 8 that extends along substantially the entire length of the lower edge of the rail member 4. The flanges 6 and 8 are spaced from the vertical surface 3 when the rail member 4 is attached to vertical surface 3 such that a space is created between the flanges 6, 8 and the vertical surface 3. The rail member 4 may have a center ridge 4a formed along the center of the rail to add rigidity to the rail member 4. In the illustrated embodiment the rail member 4 is symmetrical about its longitudinal axis such that such that the rail may be positioned with either of flanges 6 and 8 facing upward and either of flanges 6 and 8 facing downward.

A rail cover 10 is secured to the rail member 4 such that the rail member 4 is disposed behind and covered by the rail cover 10. The rail cover 10 may provide a more decorative finish to the rail and may be made of PVC or other material. The rail cover 10 has a first recess 12 formed along substantially the entire length of the interior of the top edge of rail cover 10. The rail cover 10 also has a second interior recess 14 formed along substantially the entire length of the interior of the bottom edge of rail cover 10. The first recess 12 and second recess 14 are disposed such that they are engaged by flange 6 and flange 8, respectively, to secure the cover 10 to the rail member 4. The cover 10 may be slid over the rail member 4 or the cover 10 may flex to snap onto the rail member 4. Other connection mechanisms may be used to connect the rail cover 10 to the rail member 4 such as separate fasteners. Moreover, the rail may be made of a one-piece member or multiple pieces rather than the two-piece construction shown in the Figures. One such rail system is sold by Newell Rubbermaid, Inc. under the name FAST TRACK®.

The rail cover 10 is formed with an upper engagement mechanism 20 and a lower engagement mechanism 22 for connecting the accessory 1 to the rail 2. The upper engagement mechanism 20 comprises a channel 26 that extends along the length of the upper edge of the rail 2. The channel 26 is defined by a raised edge 28 that extends along the length of the upper edge of the rail cover 10 along the front of channel 26. The lower engagement mechanism 22 comprises a rearwardly extending flange 30 that extends along the length of the lower edge of the rail cover 10 and extends toward the surface 3 and that is engaged by the accessory as will hereinafter be described.

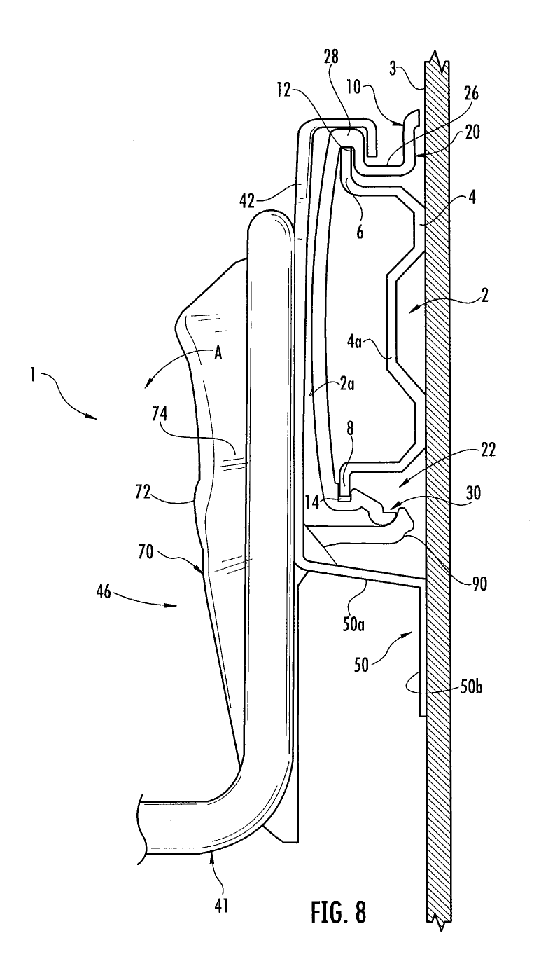

Referring to FIGS. 1 through 4, the accessory 1 comprises a gripper assembly 40 that supports a carrier or storage device 41. The gripper assembly 40 comprises a support 42 and a gripper mechanism 70. The support 42 is in the form of a plate that is dimensioned to extend from the upper edge of rail 2 to beyond the lower edge of rail 2. The support 42 faces the front face 2a of rail 2 when the accessory 1 is attached to rail 2. The support 42 has a flange 44 at its upper end that is formed as a downwardly facing hook having a substantially horizontal section 44a and a substantially downwardly extending section 44b that define a downwardly open channel 48. The flange 44 is dimensioned such that the edge 28 of rail 2 can extend into channel 48 with the downwardly extending flange 44b extending into channel 26 to suspend the accessory 1 on the rail 2. A support flange 50 extends from the bottom of support 42 and has a first section 50a that extends substantially perpendicular to the support 42 and a second section 50b that extends substantially parallel to the support 42. Support 42 is dimensioned such that flange 50 is spaced below the lower edge of rail 2. Flange 50 is dimensioned such that the second section 50b abuts or lies closely adjacent to the surface 3 on which the rail 2 is mounted when accessory 1 is mounted on rail 2 as shown in FIG. 8. Section 50b of flange 50 assists in supporting the accessory on the rail when a load is placed on the storage accessory 41. A load on the storage accessory 41 will tend to rotate the accessory counter-clockwise (as viewed in FIG. 8) such that the bottom of the accessory 1 will tend to rotate toward the support surface 3. The engagement of the flange 50 with the support surface 3 prevents or limits this motion. Flange section 50b may be provided with a hole 51 for receiving a fastener to secure the support 42 to the surface 3. The support 42 may be made of sheetmetal such as steel formed as a flat plate and bent to the desired shape such that the support 42, hook 44 and flange 50 are one-piece.

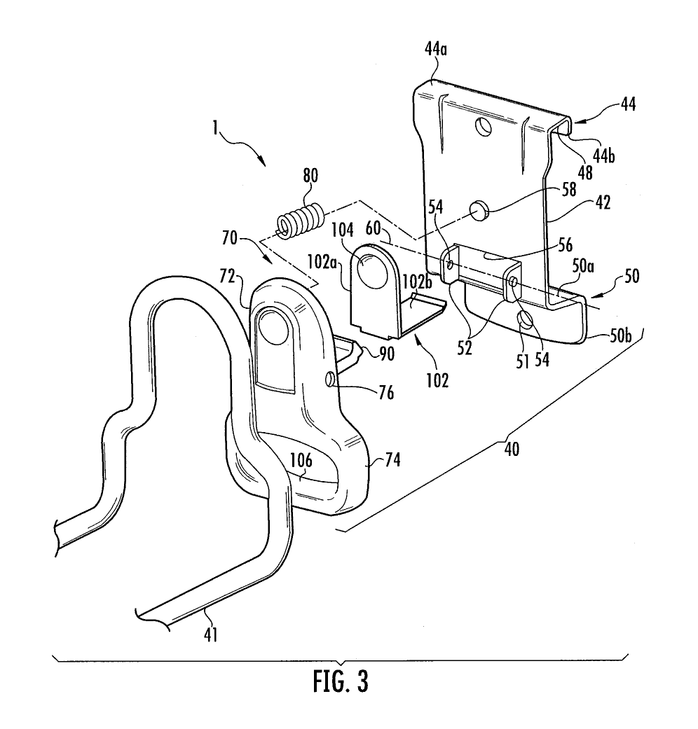

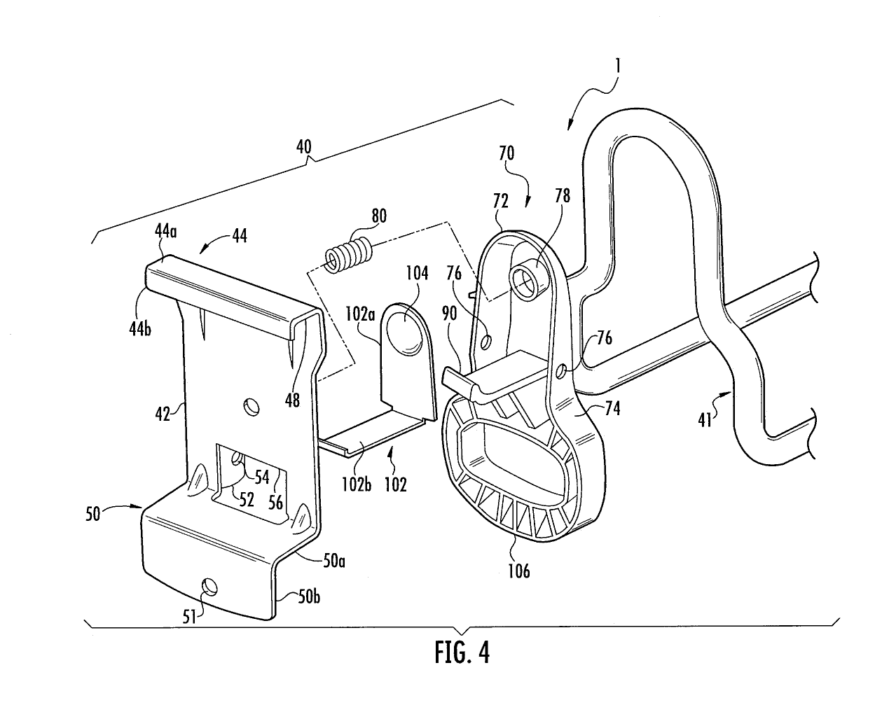

Referring more specifically to FIGS. 3 and 4, an opening 56 is formed through the support 42 where the opening 56 is disposed opposite to the lower edge of the rail 2 when the accessory 1 is mounted on the rail 2. A pivot axis 60 is formed on the opposite side of the support 42 from flanges 44 and 50 for pivotably supporting the gripper mechanism 70 as will hereinafter be described. In the illustrated embodiment the pivot axis 60 comprises two flanges 52 that extend away from the support 42 where each flange includes a pin 54 that forms the pivot. In the illustrated embodiment, where the support plate is formed of sheetmetal, the flanges 52 may be created by bending the material of the support 42 that was punched out to form opening 56. The pin 54 may be formed as projections pressed or stamped into the flanges 52. The pivot axis may also comprise, for example, a separate pin rotatably mounted to the support 42. A spring perch 58 is also formed on the support 42 on the same side as pivot axis 60. The spring perch 58 may be formed as a protrusion pressed or stamped into the sheetmetal support 42 that engages and supports one end of a compression spring 80.

The carrier or storage device 41 is attached to the support 42 such as by welding, separate fasteners, a unitary design or the like. The carrier or storage device 41 may be any device suitable for retaining or storing a wide variety of articles such as hoses, bicycles, tools, sporting equipment or the like and can include hooks, containers, bins, shelving units, cabinets or the like. In the illustrated embodiment a simple two pronged hook is illustrated as the storage device 41 although any suitable storage device may be used.

The gripper assembly 40 also comprises gripper mechanism 70 that comprises a rigid body 72 having a peripheral side wall 74. The body 72 may be formed of molded plastic. A pair of opposed holes or indentations 76 are formed in the side wall 74. The pivot pins 54 on support 42 engage the holes 76 such that the pins 54 can rotate in the holes 76 and the gripper body 72 can pivot about the pivot axis 60 relative to the support 42. A spring perch 78 is formed in the gripper body 72 that is located opposite to and faces the spring perch 58 on the support 42 for receiving the end of the spring 80. Compression spring 80 is supported on the spring perches 58, 78 and is disposed between the gripper mechanism 70 and the support 42 such that the spring 80 biases the gripper body 72 about the pivot axis 60 such that the bottom of the gripper mechanism 70 is pivoted toward support 42 and the rail 2.

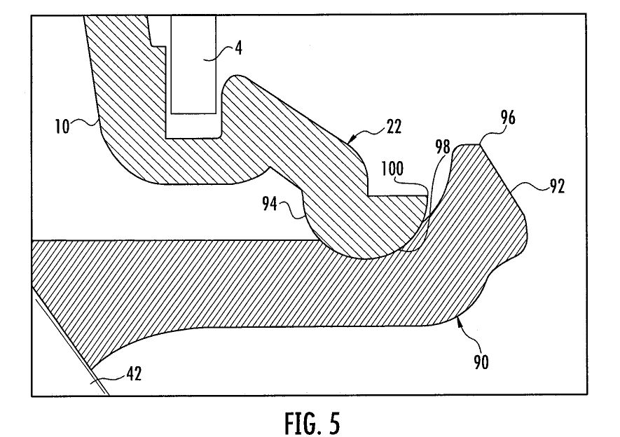

A latch 90 extends from the back side of the gripper body 72 that faces support 42 such that it extends through the hole 56 formed in the support plate 42. The latch 90 is dimensioned and arranged such that the latch 90 is positioned opposite to the lower engagement mechanism 22 when the accessory 1 is mounted on the rail 2. The latch 90 is positioned such that when the top flange 44 is hooked over the edge 28 of the rail 2 the latch 90 is disposed opposite to the lower engagement mechanism 22. Latch 90 includes a cam surface 92 where the cam surface 92 is disposed opposite to and strikes the facing cam surface 94 on the engagement mechanism 22, FIG. 5, during mounting of the accessory 1 on rail 2. The engagement of the cam surface 92 with cam surface 94 rotates the latch 90 and body 72 relative to support 42 away from the rail 2 such that the latch 90 passes under the rail 2 and engagement mechanism 22. When the distal end 96 of the latch 90 clears the bottom of the rail 2, the latch 90 and body 72 rotate relative to the support 42 by spring 80 such that the latch 90 is biased into engagement with the engagement mechanism 22 of the rail 2 to the locked position of FIGS. 5 and 8. The latch 90 is formed with a shaped mating surface 98 that engages and grips a shaped mating surface 100 formed on engagement mechanism 22 to securely lock the accessory 1 to the rail 2. In the illustrated embodiment the mating surface 98 of latch 90 includes a recess that receives a mating protrusion on the engagement mechanism 22 although this structure may be reversed.

Referring to FIGS. 1, 3 and 4, the gripper mechanism 70 may use a reinforcement member 102 to support and reinforce the latch 90 to add strength and rigidity to the latch 90. In one embodiment the reinforcement member 102 is an L-shaped steel plate having a having a first leg 102a and a second leg 102b arranged at an angle to the first leg 102a. The first leg 102a extends along and is connected to the body 72 and the second leg 102b extends along and is connected to the latch 90. In one embodiment the reinforcement member 102 is insert molded in the molded plastic gripper body 72. The reinforcement member 102 may be exposed on the front surface of the gripper body 72 such that the user may press directly on the exposed portion of reinforcement member 102 in the area above the pivot axis 60 as shown in FIG. 1. The reinforcement member 102 may have a depression 104 for identifying this location for the user. The gripper body 72 may also be rotated by the pulling the bottom of the gripper mechanism 70 away from the rail 2. In this regard the gripper body 72 may be provided with a handle 106 that can be gripped by the user. The reinforcement member 102 may be eliminated such that the gripper body and latch 90 are formed as a one piece all plastic member where area 104 is part of the plastic body.

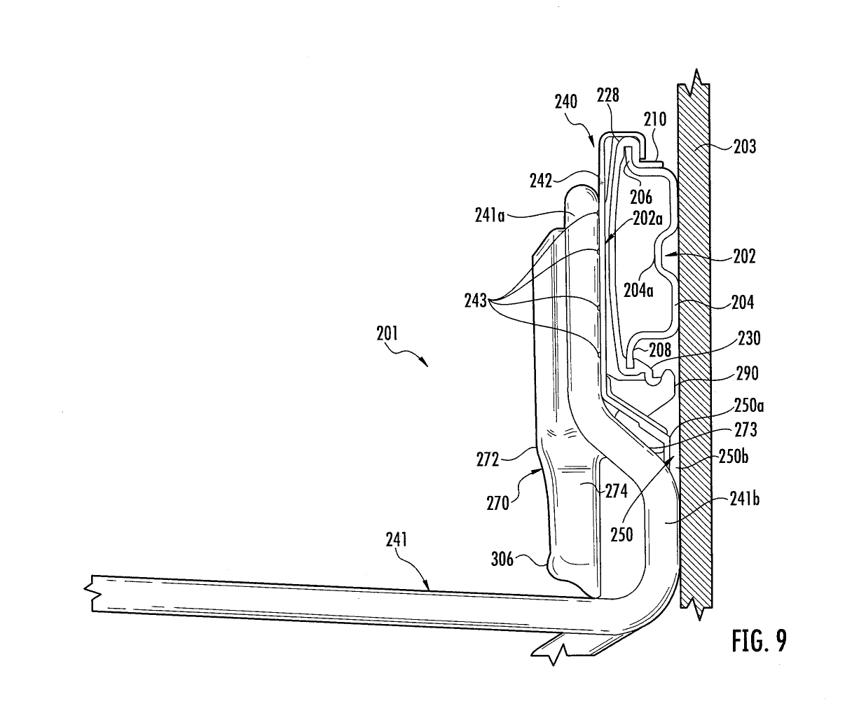

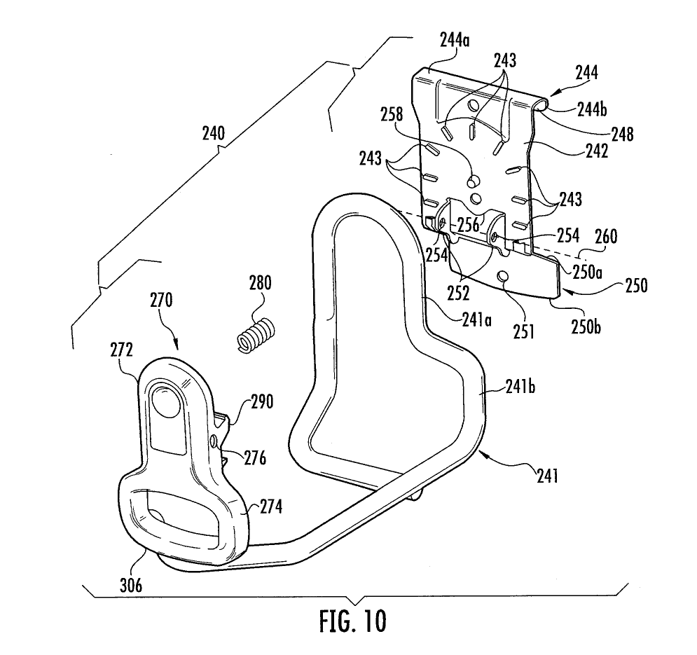

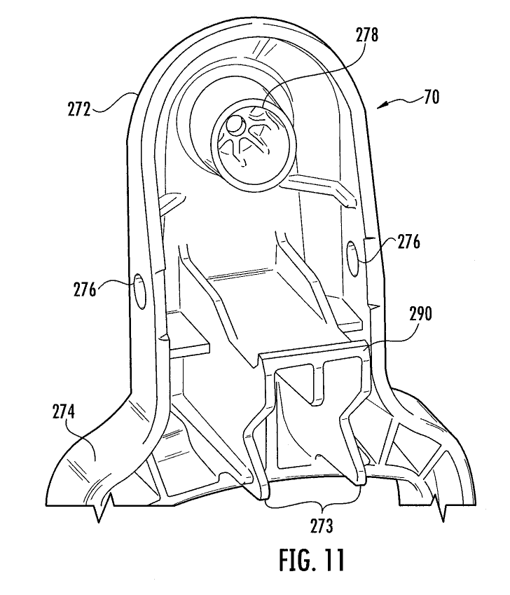

A second embodiment of the gripper assembly is shown in FIGS. 9 through 11 where the reference numerals used in FIGS. 9 through 11 are increased by 200 to identify components previously described with reference to the embodiment of FIG. 1. The gripper assembly shown in FIGS. 9 through 11 has a similar construction and operation to the embodiment of FIG. 1 except as explained below.

The gripper accessory 201 comprises a gripper assembly 240 that supports a carrier or storage device 241. The gripper assembly 240 comprises a support 242 and a gripper mechanism 270. The support 242 is in the form of a plate that is configured substantially the same as described with reference to the embodiment of FIG. 1. Support 242 also comprises a series of raised areas or projections 243 that extend from the front of support 242. The projections 243 are configured such that they match the shape of the portion 241a of storage device 241 that is attached to support 242. In the illustrated embodiment portion 241a has a inverted U-shape where the projections 243 are also formed to have an inverted U-shape where the projections are positioned on the outside edge of the portion 241a. The projections 243 engage the outer edge of portion 241a such that the projections 243 hold the storage device 241 in proper alignment relative to support 242 to prevent the storage device 241 from turning or otherwise becoming misaligned relative to support 242.

The carrier or storage device 241 is attached to the support 242 such as by welding, separate fasteners, a unitary design or the like. The carrier or storage device 241 may be any device suitable for retaining or storing a wide variety of articles such as hoses, bicycles, tools, sporting equipment or the like and can include hooks, containers, bins, shelving units, cabinets or the like. In the illustrated embodiment a simple two pronged hook made of a bent wire form is illustrated as the storage device 241 although any suitable storage device may be used. The storage device 241 is shaped such that a support portion 241b of the storage device 241b is positioned close to or abutting the vertical surface 203 on which the rail 202 is mounted. A load on the storage accessory 241 will tend to rotate the accessory counter-clockwise (as viewed in FIG. 9) such that the bottom of the storage device 241 will tend to rotate toward the support surface 203. The engagement of the portion 241b of storage device 241 with the support surface 203 prevents or limits this motion. Thus, in the embodiment of FIGS. 9 to 11 downward rotation of the storage device 241 from a load placed on the storage device is resisted both by the engagement of the flange 250 with the support surface 203, as previously described with reference to the embodiment of FIG. 1, as well as by the direct engagement of support portion 241b of the storage device 241 with the surface 203. While the support portion 241b is shown as a portion of the bent wire form that forms the illustrated hook, the support portion may be any portion of storage device 241 that contacts the support surface 203 below the rail 202.

As previously described with respect to the embodiment of FIG. 1, the gripper assembly 240 also comprises gripper mechanism 270 that comprises a rigid body 272. The body 272 may formed of molded plastic. Compression spring 280 is supported on the spring perches 258, 278 and is disposed between the gripper mechanism 270 and the support 242 such that the spring 280 biases the gripper body 272 about the pivot axis 260 such that the bottom of the gripper mechanism 270 is pivoted toward support 242 and the rail 202. A latch 290 extends from the back side of the gripper body 272 that faces support 242 such that it extends through the hole 256 formed in the support plate 242. In the embodiment of FIGS. 9-11 the body 272 and latch 290 are a unitary one-piece member and the reinforcement member 102 of the embodiment of FIG. 1 has been eliminated. The body 272 comprises supports 273 that support and reinforce latch 290 but allow the latch to flex slightly to be able to engage rail 202 as previously described. The body, latch 290 and supports 273 may be made as a one-piece unitary member such as of molded plastic.

To mount the accessory 1, 201 on the rail 2, 202, the top hook 44, 244 is located over the raised edge 28, 228 of the rail 2, 202 such that the accessory 1, 201 is suspended on the rail 2, 202 (block 701). In this position the latch 90, 290 is positioned facing the bottom edge of the rail 2, 202. The cam surface 92, 292 of latch 90, 290 may rest against the cam surface 94, 294 of the lower engagement mechanism 22, 222. The user pushes the accessory 1, 201 toward rail 2, 202 to rotate the bottom of the accessory 1, 201 towards rail 4, 204 such that latch 90, 290 moves against the engagement mechanism 22, 222 (block 702). The cam surface 92, 292 on the latch 90, 290 engages the cam surface 94, 294 on the engagement mechanism 22, 222 such that the body 72, 272 and latch 90, 290 are rotated about axis 60, 260 relative to the support 42, 242 and away from the rail 2, 202 such that the latch 90, 290 is moved generally downward as viewed in the figures (block 703). Body 72, 272 rotates about pivot axis 60, 260 such that the latch 90, 290 is rotated under rail 2, 202. As the user continues to push the bottom of accessory 1, 201 toward rail 2, 202, the latch 90, 290 passes under the bottom of the rail 2, 202 (block 704). Once the end 96, 296 of latch 90, 290 clears the end of engagement mechanism 22, 222 the body and latch are moved relative to support 42, 242 by spring 80, 280 until the mating surface 98, 298 of the latch 90, 290 engages the mating surface 100, 300 of the engagement mechanism 22, 222 to the locked position shown in FIGS. 5 and 8 (block 705). The engagement of the latch 90, 290 with the rail 2, 202 prevents the accessory 1, 202 from being inadvertently knocked off of the rail by the user even if the user applies an upward force to the accessory 1, 201.

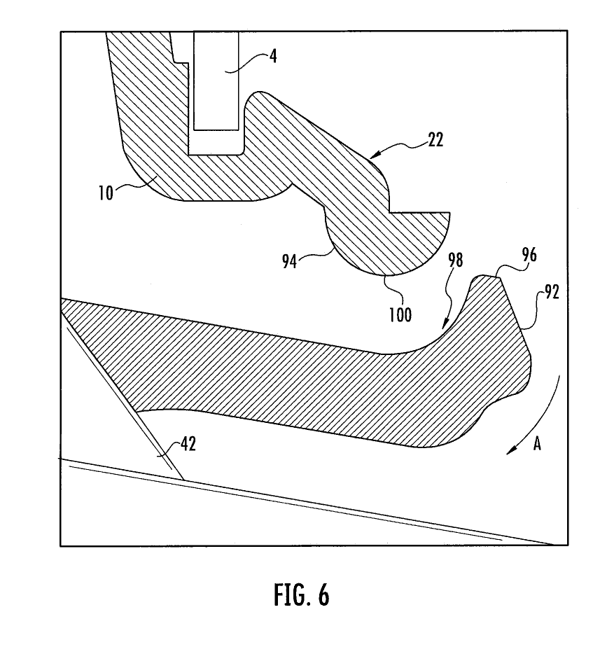

To remove the accessory 1, 201 from the rail 2, 202, the user rotates the gripper body 72, 272 relative to the support 42, 242 to release the latch 90, 290 from the engagement mechanism 22, 222 and move the gripper mechanism 70, 270 to the unlocked position shown in FIGS. 2 and 6 (block 706). The user may either pull on the bottom of the gripper body 72, 272 at handle 106, 206 or push at area 104, 304 to rotate the bottom of the gripper body 72, 272 and latch 90, 290 away from the rail 2, 202 as shown by arrow A in FIG. 6. Once the latch 90, 290 is disengaged from the rail 2, 202, the hook 44, 244 can be lifted from the top of the rail 2, 202 and the accessory 1, 201 removed from the rail (block 707).

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A storage apparatus comprising:
a rail adapted to be secured to a surface;
an accessory releasably mounted to the rail, said accessory comprising a gripper mechanism and a storage device mounted on a support, said gripper mechanism being movably mounted relative to the support such that said gripper mechanism is movable into and out of engagement with said rail when said accessory is mounted on the rail.

2. The storage apparatus of claim 1 wherein the support is dimensioned to extend from an upper edge of the rail to beyond the lower edge of the rail.

3. The storage apparatus of claim 1 wherein the support has a hook that engages the upper edge of the rail.

4. The storage apparatus of claim 3 wherein the accessory is suspended on the rail by the hook.

5. The storage apparatus of claim 2 wherein a flange extends below the rail and is dimensioned such that the flange abuts or lies closely adjacent to the surface when the accessory is mounted on the rail.

6. The storage apparatus of claim 1 wherein said gripper mechanism comprises a latch engageable with an engagement mechanism on the rail.

7. The storage apparatus of claim 6 wherein a spring biases said latch toward the engagement mechanism.

8. The storage apparatus of claim 7 further including a spring perch on the gripper mechanism located opposite to and facing a spring perch on the support.

9. The storage apparatus of claim 6 wherein the latch extends through a hole in the support.

10. The storage apparatus of claim 6 wherein the latch is positioned opposite to the engagement mechanism when the accessory is mounted on the rail.

11. The storage apparatus of claim 10 wherein said latch includes a first cam surface that is disposed opposite to a second cam surface on the engagement mechanism.

12. The storage apparatus of claim 11 wherein the engagement of the first cam surface with the second cam surface rotates the latch relative to the support.

13. The storage apparatus of claim 12 wherein when a distal end of the latch clears the engagement mechanism, the latch is biased into engagement with the engagement mechanism.

14. The storage apparatus of claim 6 wherein the latch comprises a first mating surface that engages and grips a second mating surface on the engagement mechanism.

15. The storage device of claim 6 further including a reinforcement member supporting the latch to add rigidity to the latch.

16. The storage device of claim 15 wherein the reinforcement member is insert molded in the gripper mechanism.

17. A method of mounting an accessory on a rail that is mounted on a surface comprising:
providing a gripper assembly having a support with a hook and a gripper mechanism movable relative to the support, said gripper mechanism comprising a latch;
locating the hook over an edge of the rail such that the accessory is suspended on the rail from the hook;
moving the gripper mechanism to engage the rail with the latch such that the latch is moved relative to the support and away from the rail;
allowing the latch to move toward the rail until a first surface on the latch engages a second surface on the rail.

18. The method of claim 17 further comprising:
moving the gripper mechanism relative to the support to disengage the latch from the rail.

19. The method of claim 18 further comprising;
after the latch is disengaged from the rail, lifting the hook from the edge of the rail.

20. An accessory for a storage apparatus comprising a rail, said accessory comprising:
a gripper mechanism and a storage device, said gripper mechanism being movably mounted relative to a support such that said gripper mechanism is movable from a first position where a latch is positioned to engage the rail and a second position where the latch is positioned to be disengaged from the rail, said gripper mechanism being biased to said first position.
